(19) United States
(12) Patent Application Publication
(10) Pub. No.: US 2013/0026994 A1
(43) Pub. Date: Jan. 31, 2013

(54) BATTERY CELL MONITORING CIRCUIT, BATTERY CELL MODULE, AUTOMOBILE WITH BATTERY CELL MODULE

(71) Applicant: Masaaki MORIKAWA, Kanagawa-ken (JP)

(72) Inventor: Masaaki MORIKAWA, Kanagawa-ken (JP)

(73) Assignee: Kabushiki Kaisha Toshiba, Tokyo (JP)

(21) Appl. No.: 13/421,822

(22) Filed: Mar. 15, 2012

(30) Foreign Application Priority Data
Jul. 27, 2011 (JP) 2011-164415

(51) Int. Cl. H02J 7/00

(52) U.S. Cl. 320/134

(57) ABSTRACT

According to one embodiment, a battery cell monitoring circuit detects an abnormity in the cell balancing and terminals of each battery cell. One end of the first switch is connected to the first cell balancing terminal, and the other end of the first switch is connected to the second cell balancing terminal, so that the first switch is turned on/off based on a first control signal to perform cell balancing. The current source and the second switch are arranged in parallel with the first switch, and are connected in series between the one end and the other end of the first switch. The current source supplies a current. The second switch is turned on/off based on a second control signal. The first detection unit receives a first cell voltage measuring terminal voltage and a first cell balancing terminal voltage, and detects a terminal open state. The second detection unit receives a second cell voltage measuring terminal voltage and a second cell balancing terminal voltage, and detects a terminal open state.

### CROSS REFERENCE TO RELATED APPLICATION

This application is based upon and claims the benefit of priority from the prior Japanese Patent Application No. 2011-164415, filed on Jul. 27, 2011, the entire contents of which are incorporated herein by reference.

### FIELD

The embodiments described herein are related to a battery cell monitoring circuit, a battery cell module, and an automobile with a battery cell module.

### BACKGROUND

Battery cell modules are applied to the fields such as automobile industry for EVs (electric vehicles), HVs (hybrid electric vehicles), or the like, Energy Harvesting, and Smart Grid. Each battery cell module includes a plurality of stacked battery cells, for example. Each battery cell module includes a battery cell monitoring circuit configured to monitor the battery cells. The battery cell monitoring circuit detects a voltage across the terminals of each battery cell, and detects an overcharge, an overdischarge, and the like of the battery cell.

In order for the battery cell module to monitor the battery cells with high precision, it is effective to provide each of the positive electrode and the negative electrode of each battery cell with a cell voltage measuring terminal and a cell balancing terminal independently of each other. In the case where the cell voltage measuring terminal and the cell balancing terminal are independently provided, a battery cell, if overcharged, is discharged with a cell balancing switch turned on. At that discharge, the voltage across the cell voltage measuring terminals is not changed. In addition, the cell voltage can be measured with cell balancing.

However, in the battery cell monitoring circuit described above, there is a problem that it is difficult to immediately detect an abnormity in the cell balancing terminals and the cell balancing switch.

### BRIEF DESCRIPTION OF THE DRAWINGS

FIG. 1 is a diagram illustrating the schematic configuration of an automobile including a battery cell module according to a first embodiment;

FIG. 2 is a circuit diagram illustrating the schematic configuration of a battery cell monitoring circuit and a battery cell according to the first embodiment;

FIG. 3 is a flowchart illustrating an open detection operation of the battery cell monitoring circuit according to the first embodiment;

FIG. 4(a) is a timing chart illustrating the open detection operation of the battery cell monitoring circuit according to the first embodiment in the case where the cell balancing terminal is normal;

FIG. 4(b) is a timing chart illustrating the open detection operation of the battery cell monitoring circuit according to the first embodiment in the case where the cell balancing terminal is open;

FIG. 5 is a circuit diagram illustrating the schematic configuration of a battery cell monitoring circuit and a battery cell according to a second embodiment;

FIG. 6(a) is a timing chart illustrating the open detection operation of the battery cell monitoring circuit according to the second embodiment in the case where the cell balancing terminal is normal;

FIG. 6(b) is a timing chart illustrating the open detection operation of the battery cell monitoring circuit according to the second embodiment in the case where the cell balancing terminal is open;

FIG. 7(a) is a timing chart illustrating the short detection operation of the battery cell monitoring circuit according to the second embodiment when the cell balancing switch is OFF;

FIG. 7(b) is a timing chart illustrating the short detection operation of the battery cell monitoring circuit according to the second embodiment when the cell balancing switch has a short-circuit failure;

FIG. 8 is a circuit diagram illustrating the schematic configuration of a battery cell monitoring circuit and a battery cell according to a third embodiment;

FIG. 9(a) is a timing chart illustrating the current detection operation of the battery cell monitoring circuit according to the third embodiment when the cell balancing terminal is normal; and

FIG. 9(b) is a timing chart illustrating the current detection operation of the battery cell monitoring circuit according to the third embodiment in the case where the cell balancing terminal is open.

### DETAILED DESCRIPTION

According to one embodiment, a battery cell monitoring circuit detects an abnormity in the cell balancing and terminals of each battery cell. The battery cell monitoring circuit includes a first cell voltage measuring terminal, a first cell balancing terminal, a second cell voltage measuring terminal, a second cell balancing terminal, a first switch, a current source, a second switch, a first detection unit, and a second detection unit. The first cell voltage measuring terminal is connected to the positive electrode side of the battery cell. The first cell balancing terminal is connected to the positive electrode side of the battery cell, and is arranged in parallel with the first cell voltage measuring terminal. The second cell voltage measuring terminal is connected to the negative electrode side of each battery cell. The second cell balancing terminal is connected to the negative electrode side of the battery cell, and is arranged in parallel with the second cell voltage measuring terminal. One end of the first switch is connected to the first cell balancing terminal, and the other end of the first switch is connected to the second cell balancing terminal, so that the first switch is turned on/off based on a first control signal to perform cell balancing. The current source and the second switch are arranged in parallel with the first switch, and are connected in series between the one end and the other end of the first switch. The current source supplies a current. The second switch is turned on/off based on a second control signal. The first detection unit receives a first cell voltage measuring terminal voltage and a first cell balancing terminal voltage, and detects a terminal open state. The second detection unit receives a second cell voltage measuring terminal voltage and a second cell balancing terminal voltage, and detects a terminal open state.

According to another embodiment, a battery cell module includes a battery cell unit in which battery cells are stacked or arranged in parallel, and a battery cell monitoring circuit configured to detect an abnormity in the cell balancing and terminals of each battery cell. The battery cell monitoring circuit includes a first cell voltage measuring terminal, a first cell balancing terminal, a second cell voltage measuring terminal, a second cell balancing terminal, a first switch, a current source, a second switch, a first detection unit, and a second detection unit. The first cell voltage measuring terminal is connected to the positive electrode side of the battery cell. The first cell balancing terminal is connected to the positive electrode side of the battery cell, and is arranged in parallel with the first cell voltage measuring terminal. The second cell voltage measuring terminal is connected to the negative electrode side of the battery cell. The second cell balancing terminal is connected to the negative electrode side of the battery cell, and is arranged in parallel with the second cell voltage measuring terminal. One end of the first switch is connected to the first cell balancing terminal, and the other end of the first switch is connected to the second cell balancing terminal, so that the first switch is turned on/off based on a first control signal to perform cell balancing. The current source and the second switch are arranged in parallel with the first switch, and are connected in series between the one end and the other end of the first switch. The current source supplies a current. The second switch is turned on/off based on a second control signal. The first detection unit receives a first cell voltage measuring terminal voltage and a first cell balancing terminal voltage, and detects a terminal open state. The second detection unit receives a second cell voltage measuring terminal voltage and a second cell balancing terminal voltage, and detects a terminal open state.

Hereinafter, a plurality of further embodiments will be described with reference to the drawings. In the drawings, the same reference symbol indicates the same or similar portion.

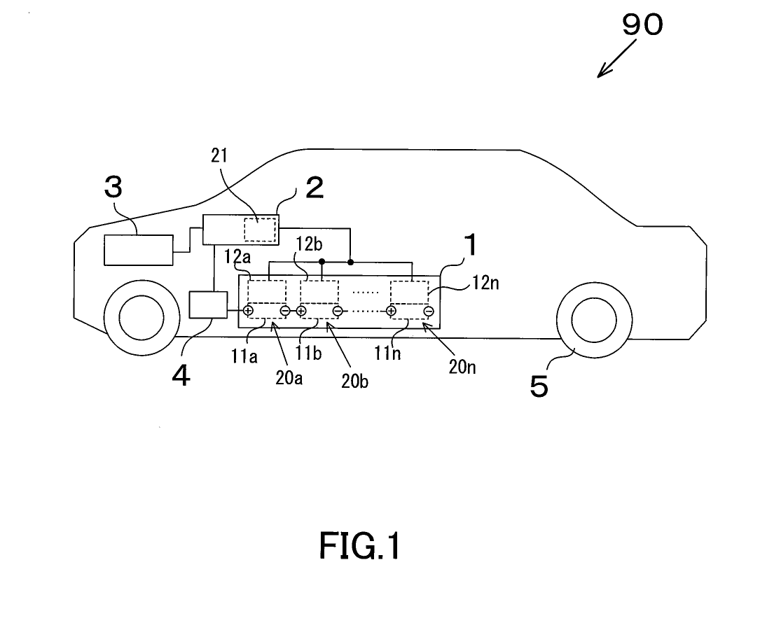

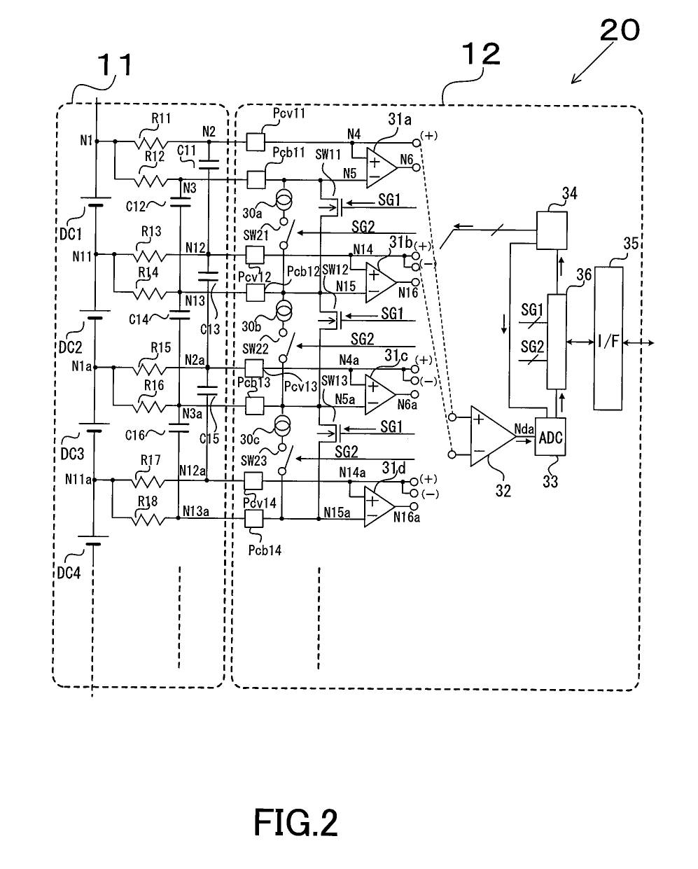

A battery cell monitoring circuit, a battery cell module, and an automobile with a battery cell module according to a first embodiment will be described with reference to the drawings. FIG. 1 is a diagram illustrating the schematic configuration of an automobile including a battery cell module according to the first embodiment. FIG. 2 is a circuit diagram illustrating the schematic configuration of the battery cell monitoring circuit and the battery cell. In the embodiment, a detection circuit is provided in the battery cell monitoring circuit in order to immediately detect an open state of the cell balancing terminal.

As illustrated in FIG. 1, an automobile 90 includes a battery cell module unit 1, an ECU 2, an engine 3, an inverter 4, and a tire 5. The automobile 90 is an EV (electric vehicle).

The ECU (electronic control unit for automobiles) 2 is provided with an MCU (micro controller unit) 21. The MCU (micro controller unit) 21 electronically controls the battery cell module unit 1, the engine 3, the inverter 4, and the like. Normally, the automobile 90 is provided with four tires 5.

In the battery cell module section 1, n battery cell modules, i.e., a battery cell module 20a, a battery cell module 20b, . . . a battery cell module 20n are arranged in series. The battery cell module 20a includes a battery cell unit 11a and a battery cell monitoring circuit 12a. The battery cell module 20b includes a battery cell unit 11b and a battery cell monitoring circuit 12b. The battery cell module 20n includes a battery cell unit 11n and a battery cell monitoring circuit 12n.

The n battery cell modules, i.e., the battery cell module 20a, the battery cell module 20b, . . . the battery cell module 20n are connected in series with each other. The positive electrode side of battery cell unit 11a is connected to the (+) side of the inverter 4, and the negative electrode side is connected to the positive electrode side of the battery cell unit 11b. The negative electrode side of battery cell unit 11b is connected to the positive electrode side of the battery cell unit 11c, which is not shown. The positive electrode side of battery cell unit 11n is connected to the negative electrode side of the battery cell unit 11(n−1), which is not shown. The positive electrode side of the battery cell unit 11a, and the negative electrode side of the battery cell unit 11n are connected to a battery management unit (not shown), for example. The (+) and (−) sides of the inverter 4 are connected to the battery management unit. The battery management unit manages the voltage across the positive electrode side of the battery cell unit 11a and the negative electrode side of the battery cell unit 11n.

The battery cell monitoring circuit 12a monitors the battery cell unit 11a, the battery cell monitoring circuit 12b monitors the battery cell unit 11b, and the battery cell monitoring circuit 12n monitors the battery cell unit 11n. N battery cell modules, the battery cell module 20a, the battery cell module 20b, . . . the battery cell module 20n have a configuration which allows each battery cell module to be independently detached and replaced with another battery cell module. N battery cell units, the battery cell unit 11a, the battery cell unit 11b, . . . the battery cell unit 11n also have a configuration which allows each battery cell unit to be independently detached and replaced with another battery cell unit.

Because the battery cell unit 11a, the battery cell unit 11b, . . . and the battery cell unit 11n have a similar configuration, and the battery cell monitoring circuit 12a, the battery cell monitoring circuit 12b, . . . and the battery cell monitoring circuit 12n have a similar configuration, the internal configurations of the battery cell unit 11 and the battery cell monitoring circuit 12 that constitute the battery cell module 20 are described.

As illustrated in FIG. 2, the battery cell unit 11 includes battery cells DC1 to DC4, resistances R11 to R18, and condensers C11 to C16. The battery cell monitoring circuit 12 includes cell voltage measuring terminals Pcv11 to Pcv14, cell balancing terminals Pcb11 to Pcb14, current sources 30a to 30c, switches SW11 to SW13, switches SW21 to SW23, detection circuits 31a to 31d, a differential amplifier 32, an AD converter 33, a sequencer circuit 34, an interface unit 35, and a register 36.

Here, the notations subsequent to the battery cell unit DC4, the resistance R18, and the condenser C16 are omitted. The notations subsequent to the cell voltage measuring terminal Pcv14, the cell balancing terminal Pcb14, the current source 30c, the switch SW13, and the switch SW23 are also omitted.

In the case where the positive electrode side and the negative electrode side of the battery cell 11 are provided with the cell voltage measuring terminals and the cell balancing terminals, when a battery cell is overcharged, the battery cell is discharged by turning on one of the cell balancing switches (switches 11 to 13). However, at the time of the discharge, the voltage at the cell voltage measuring terminal is not changed. In addition, advantageously, measurement of the cell voltage can be made while performing cell balancing.

The positive electrode side of the battery cell DC1 is connected to a Node N1, while the negative electrode side of the battery cell DC1 is connected to a Node N11 and the positive electrode side of the battery cell DC2. The positive electrode side of the battery cell DC3 is connected to the negative electrode side of the battery cell DC2, while the negative electrode side of the battery cell DC3 is connected to the positive electrode side of the battery cell DC4.

One end of the resistance R11 is connected to the Node N1 and the positive electrode side of battery cell DC1, while the other end of the resistance R11 is connected to a Node N2 and a cell voltage measuring terminal Pcv11. One end of the resistance R12 is connected to the Node N1 and the battery cell DC1, while the other end of the resistance R12 is connected to a Node N3 and a cell balancing terminal Pcb11.

One end of the resistance R13 is connected to the Node N1, the negative electrode side of the battery cell DC1, and the positive electrode side of the battery cell DC2, while the other end of the resistance R13 is connected to a Node N12 and the cell voltage measuring terminal Pcv12. One end of the resistance R14 is connected to the Node N11, the negative electrode side of the battery cell DC1, and the positive electrode side of the battery cell DC2, while the other end of the resistance R14 is connected to the Node N13 and the cell balancing terminal Pcv12.

One end of the resistance R15 is connected to a Node N1a, the negative electrode side of the battery cell DC2, and the positive electrode side of the battery cell DC3, while the other end of the resistance R15 is connected to a Node N2a and the cell voltage measuring terminal Pcv13. One end of the resistance R16 is connected to the Node N1a, the negative electrode side of the battery cell DC2, and the positive electrode side of the battery cell DC3, while the other end of the resistance R16 is connected to a Node N3a and the cell balancing terminal Pcb13.

One end of the resistance R17 is connected to a Node N11a, the negative electrode of the battery cell DC3, and the positive electrode side of the battery cell DC4, while the other end of the resistance R17 is connected to a Node N12a and the cell voltage measuring terminal Pcv14. One end of the resistance R18 is connected to the Node N11a, the negative electrode side of the battery cell DC3, and the positive electrode side of the battery cell DC4, while the other end of the resistance R18 is connected to a Node N13a and the cell balancing terminal Pcb14. Here, the resistances R11 to R18 serve as a resistance to set a discharge current of each battery cell.

One end the condenser C11 is connected to the Node N2 and the cell voltage measuring terminal Pcv11, while the other end the condenser C11 is connected to the Node N12 and the cell voltage measuring terminal Pcv12. One end the condenser C12 is connected to the Node N3 and the cell balancing terminal Pcb11, while the other end the condenser C12 is connected to the Node N13 and the cell balancing terminal Pcv12. One end the condenser C13 is connected to the Node N12 and the cell voltage measuring terminal Pcv12, while the other end the condenser C13 is connected to the Node N2a and the cell voltage measuring terminal Pcv13. One end the condenser C14 is connected to the Node N13 and the cell balancing terminal Pcb12, while the other end the condenser C14 is connected to the Node N3a and the cell balancing terminal Pcv13. One end the condenser C15 is connected to the Node N2a and the cell voltage measuring terminal Pcv13, while the other end the condenser C15 is connected to the Node N12a and the cell voltage measuring terminal Pcv14. One end the condenser C16 is connected to the Node N3a and the cell balancing terminal Pcb13, while the other end the condenser C16 is connected to the Node N13a and the cell balancing terminal Pcv14. Here, each of the condensers C11 to 16 and each of externally attached resistances (not shown) are constituted filter (LPF), respectively. The filter (LPF) reduces the noise toward the cell voltage measuring terminals and the cell balancing terminals.

The detection circuit 31a as a detection unit is a comparator. The + (positive) port of the detection circuit 31a on the input side is connected to a Node N4 and the cell voltage measuring terminal Pcv11, and the − (negative) port of the detection circuit 31a on the input side is connected to a Node N5 and the cell balancing terminal Pcb11 so that the detection circuit 31a compares the voltages at the Nodes N4 and N5, and outputs a result of the comparison to a Node N6 on the output side.

The detection circuit 31b as a detection unit is a comparator. The + (positive) port of the detection circuit 31b on the input side is connected to a Node N14 and the cell voltage measuring terminal Pcv12, and the − (negative) port of the detection circuit 31b on the input side is connected to a Node N15 and the cell balancing terminal Pcb12 so that the detection circuit 31b compares the voltages at the Nodes N14 and N15, and outputs a result of the comparison to a Node N16 on the output side.

The detection circuit 31c as a detection unit is a comparator. The + (positive) port of the detection circuit 31c on the input side is connected to a Node N4a and the cell voltage measuring terminal Pcv13, and the − (negative) port of the detection circuit 31c on the input side is connected to a Node N5a and the cell balancing terminal Pcb13 so that the detection circuit 31c compares the voltages at the cell voltage measuring terminal Pcv13 and the cell balancing terminal Pcb13, and outputs a result of the comparison to a Node N6a on the output side.

The detection circuit 31d is a comparator. The + (positive) port of the detection circuit 31d on the input side is connected to a Node N14a and the cell voltage measuring terminal Pcv14, and the − (negative) port of the detection circuit 31d on the input side is connected to a Node N15a and the cell balancing terminal Pcb14 so that the detection circuit 31d compares the voltages at the cell voltage measuring terminal Pcv14 and the cell balancing terminal Pcb14, and outputs a result of the comparison to a Node N16a on the output side.

One end of the switch SW11 is connected to the cell balancing terminal Pcb11, the other end of the switch SW11 is connected to the cell balancing terminal Pcb12. The switch SW11 is turned on/off based on a control signal SG1, and serves as a cell balancing switch. A drain of an N-channel MOS transistor as the switch SW11 is connected to the Node N5 and the cell balancing terminal Pcb11, the control signal SG1 is inputted to a gate of the N-channel MOS transistor as the switch SW11, and a source of the N-channel MOS transistor as the switch SW11 is connected to the Node N15 and the cell balancing terminal Pcb12.

One end of the switch SW12 is connected to the cell balancing terminal Pcb12, the other end of the switch SW12 is connected to the cell balancing terminal Pcb13. The switch SW12 is turned on/off based on a control signal SG1, and serves as a cell balancing switch. A drain of an N-channel MOS transistor as the switch SW12 is connected to the Node N15 and the cell balancing terminal Pcb12, the control signal SG1 is inputted to a gate of the N-channel MOS transistor as the switch SW12, and a source of the N-channel MOS transistor as the switch SW12 is connected to the Node N5a and the cell balancing terminal Pcb13.

One end of the switch SW13 is connected to the cell balancing terminal Pcb13, the other end of the switch SW13 is connected to the cell balancing terminal Pcb14. The switch SW13 is turned on/off based on a control signal SG1, and serves as a cell balancing switch. A drain of an N-channel MOS transistor as the switch SW13 is connected to the Node N5a and the cell balancing terminal Pcb13, the control signal SG1 is inputted to a gate of the N-channel MOS transistor as the switch SW13, and a source of the N-channel MOS transistor as the switch SW13 is connected to the Node N15a and the cell balancing terminal Pcb14.

The cell balancing process is performed such that each of the switches SW11 to 13 is independently turned on or off based on the control signal SG1, and thus an excessively charged battery cell is discharged. Consequently, in a plurality of battery cells, a resistance discharge is performed independently.

The current source 30a and the switch SW21 are connected in series. One end of the current source 30a is connected to the Node N5 and the cell balancing terminal Pcb11. One end of the switch SW21 is connected to the other end of the current source 30a, and the other end of the switch SW21 is connected to the Node N15 and the cell balancing terminal Pcb12 so that the switch SW21 is turned on or off based on a control signal SG2.

The current source 30b and the switch SW22 are connected in series. One end of the current source 30b is connected to the Node N5 and the cell balancing terminal Pcb12. One end of the switch SW22 is connected to the other end of the current source 30b, and the other end of the switch SW22 is connected to the Node N5a and the cell balancing terminal Pcb13 so that the switch SW22 is turned on or off based on the control signal SG2.

The current source 30c and the switch SW23 are connected in series. One end of the current source 30c is connected to the Node N5a and the cell balancing terminal Pcb13. One end of the switch SW23 is connected to the other end of the current source 30c, and the other end of the switch SW23 is connected to the Node N15a and the cell balancing terminal Pcb14 so that the switch SW23 is turned on or off based on the control signal SG2.

The + (positive) port of the differential amplifier 32 on the input side is connected to the positive electrode side of each battery cell, and the − (negative) port of the differential amplifier 32 on the input side is connected to the negative electrode side of the battery cell so that the differential amplifier 32 outputs a difference (battery cell voltage) detection signal from a Node Nda on the output side. Here, the positive electrode side of the battery cell DC1 (indicated as (+) at the Node N4), and the negative electrode side of the battery cell DC1 (indicated as (−) at the Node N14) are selected based on a signal outputted from the sequencer circuit 34 so that the voltage of the battery cell DC1 is measured.

The AD converter 33 receives an input signal outputted from the differential amplifier 32 via the Node Nda and converts the difference (battery cell voltage) value to a digital value. A 12-bit ΔΣAD converter, for example, is used as the AD converter 33.

The register 36 stores the battery cells related supervisory information of the battery cell monitoring circuit 12, and distributes various control signals (including the control signals SG1 and SG2) outputted from the MCU 21 to the inside of the battery cell monitoring circuit 12.

The sequencer circuits 34 receives a control signal outputted from the MCU 21 via the register 36, and controls a timing for switching between the positive and negative electrode sides of the battery cell based on the control signal. The voltage of the battery cell to be measured by the differential amplifying circuit 32 is determined by the switching timing of the sequencer circuits 34.

The interface unit 35 bidirectionally communicates with the MCU 21. Various control signals generated by the MCU 21, for example, are inputted to the battery cell monitoring circuit 12 via the interface unit 35. The battery cell related supervisory information of the battery cell monitoring circuit 12 is outputted via interface unit 35.

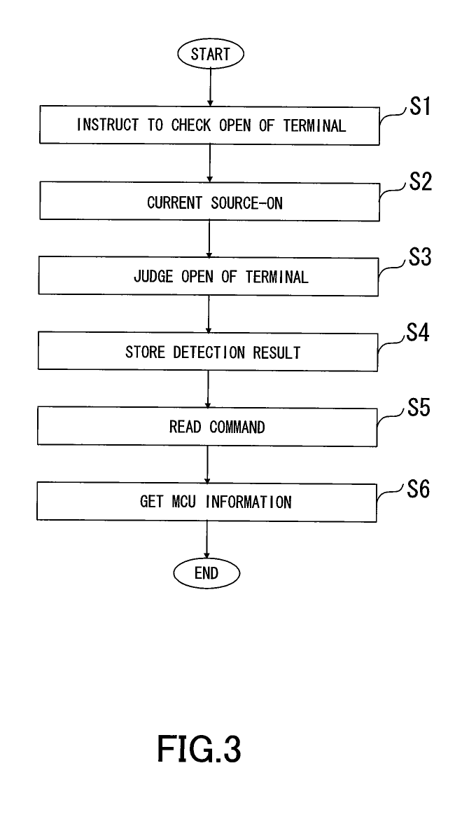

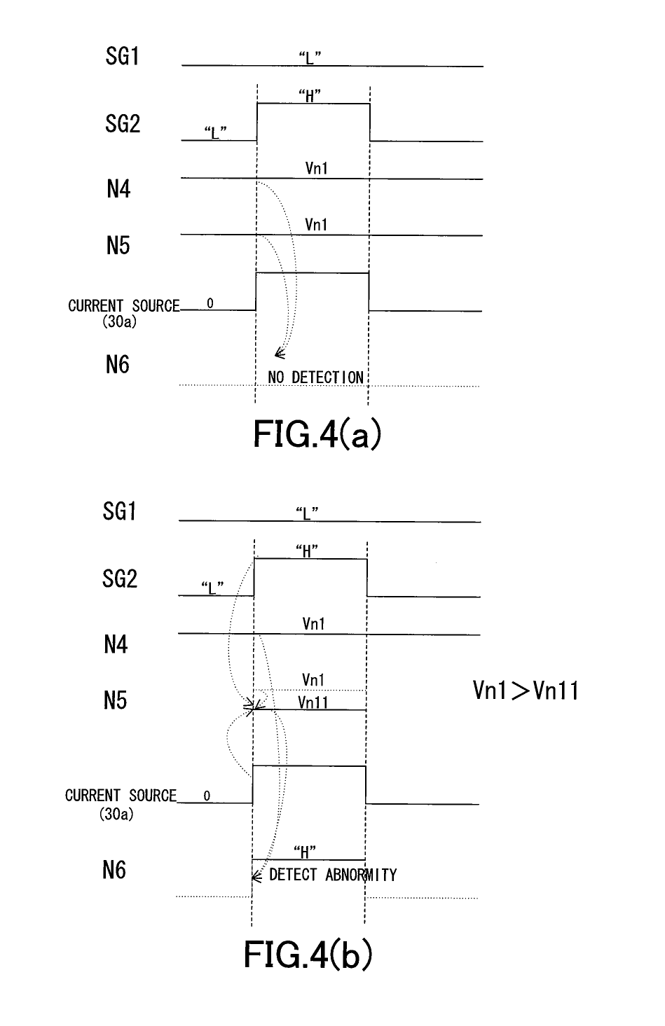

Next, detection of an abnormity of a cell balancing terminal by the battery cell monitoring circuit is described with reference to FIGS. 3 and 4. FIG. 3 is a flowchart illustrating the open detection operation of the battery cell monitoring circuit.

As illustrated in FIG. 3, at first, the MCU 21 transmits a terminal open check command to the battery cell monitoring circuit 12. Specifically, the MCU 21 transmits the control signal SG1 and the control signal SG2 (Step S1).

Next, the battery cell monitoring circuit 12 turns on the current source based on the terminal open check command. The control signal SG2 in an enable state, for example, is inputted to the switch SW21 of the battery cell monitoring circuit 12 to turn on the switch SW21 so that a current flows between the Node 5 and the Node N15.

Subsequently, a determination on whether or not a terminal is open is performed. FIG. 4(a) is a timing chart illustrating the open detection operation of the battery cell monitoring circuit in the case where the cell balancing terminal is normal. FIG. 4(b) is a timing chart illustrating the open detection operation of the battery cell monitoring circuit in the case where the cell balancing terminal is open. Here, determination on whether or not the cell balancing terminal Pcb11 is open is described as an example.

As illustrated in FIG. 4(a), when the cell balancing terminal Pcb11 and the cell balancing terminal Pcb12 are normal, the switch SW11 is turned off with the control signal SG1 of a low level in a disable state, and the switch SW21 is turned on with the control signal SG2 of a high level in an enable state, and then a current flows through the current source 30a. At the moment, the Node N4 and the Node N5 have the same potential (voltage Vn1 at the Node N1) because the Node N5 is electrically connected to the positive electrode side of the battery cell DC1. Thus, a detection signal as a voltage difference is not detected by the detection circuit 31a.

As illustrated in FIG. 4(b), when the cell balancing terminal Pcb12 is normal and the cell balancing terminal Pcb11 is open, the switch SW11 is turned off with the control signal SG1 of a low level in a disable state, and the switch SW21 is turned on with the control signal SG2 of a high level in an enable state, and then a current flows through the current source 30a. At the moment, the Node N5 has the voltage (voltage Vn11 at the Node N11) at the negative electrode side of the battery cell DC1 because the Node N5 is not electrically connected to the positive electrode side of the battery cell DC1. Thus, a detection signal at a high level (signal at a high level at the Node N6) as a voltage difference is detected by the detection circuit 31a. That is to say, the detection circuit 31a can determine that the cell balancing terminal Pcb11 is open. It should be noted that a detection result by the detection circuit 31a is determined by a determination unit (not shown) of the battery cell monitoring circuit 12.

A normal or open state is determined for each of the other cell balancing terminals in a similar manner so that an existence of an abnormity of a cell balancing terminal is checked (Step S3).

A determined result of the normal or open state of the cell balancing terminal is then stored in the register 36 via the determination unit (Step S4).

Next, after the determined result is stored in the register 36, the MCU 21 transmits a read command to the battery cell monitoring circuit 12 (Step S5).

Subsequently, the MCU 21 obtains the determined result from the battery cell monitoring circuit 12. The MCU 21 recognizes which cell balancing terminal is in an open failure, and determines whether or not to repair or replace a battery cell module and/or a battery cell unit in which an open failure occurs. Based on the determination, the relevant battery cell module and/or battery cell unit is repaired or replaced (Step S6).

As described above, the battery cell monitoring circuit, the battery cell module and the automobile with the battery cell module of the embodiment are each provided with the battery cell module unit 1, the ECU, the engine 3, the inverter 4, and the tire 5. In the battery cell module section 1, n battery cell modules, i.e., the battery cell module 20a, the battery cell module 20b, . . . the battery cell module 20n are arranged in series. The battery cell module 20 includes the battery cell unit 11 in which battery cells are stacked, and the battery cell monitoring circuit 12. The battery cell monitoring circuit 12 includes the cell voltage measuring terminals Pcv11 to Pcv14, the cell balancing terminals Pcb11 to Pcb14, the current sources 30a to 30c, the switches SW11 to SW13, the switches SW21 to SW23, the detection circuits 31a to 31d, the differential amplifier 32, the AD converter 33, the sequencer circuit 34, the interface unit 35, and the register 36. The detection circuit of battery cell monitoring circuit 12 compares the voltage at the + (positive) port on the input side with the voltage at the − (negative) port on the input side based on the low-level control signal SG1 and the high-level control signal SG2. A result of the comparison is transmitted to the MCU 21.

Accordingly, whether or not a cell balancing terminal is in an open failure can be immediately determined. The MCU 21 can recognize a result of an abnormity of the cell balancing terminal swiftly. Consequently, when an abnormity occurs in a battery cell module, the relevant battery cell unit and/or battery cell monitoring circuit can be immediately repaired or replaced, and thus the safety of the automobile 90 can be improved.

It should be noted that although the battery cell monitoring circuit 12 is applied to an EV in the embodiment, the invention is not necessarily limited to the above case. The battery cell monitoring circuit 12 may be applied to an HEV (hybrid electric vehicle), a fuel cell vehicle, smart grid, energy harvesting, a mobile, and the like.

In addition, an N-channel MOS transistor is used for switches SW11 to 13 in the embodiment, however, the invention is not necessarily limited to the above case. A transfer gate, for example, may be used alternatively.

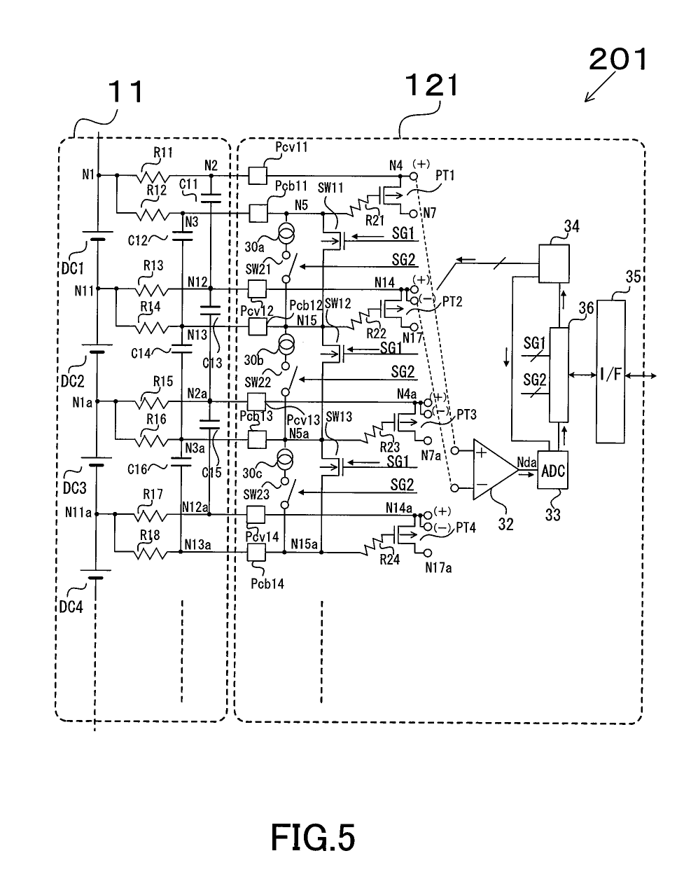

A battery cell monitoring circuit, a battery cell module, and an automobile with a battery cell module according to a second embodiment will be described with reference to the drawings. FIG. 5 is a circuit diagram illustrating the schematic configuration of the battery cell monitoring circuit and the battery cell. In the embodiment, the detection circuit of the battery cell monitoring circuit is replaced by a P-channel MOS transistor.

Hereinafter, the same components as those of the first embodiment are labeled with the same reference symbols and description is omitted, and only different components are described.

As illustrated in FIG. 5, a battery cell module 201 is provided with a battery cell 11 and a battery cell monitoring circuit 121. Similarly to the first embodiment, the battery cell module 201 constitutes the battery cell module, which is mounted on an automobile.

The battery cell unit 11 includes battery cells DC1 to DC4, resistances R11 to R18, and condensers C11 to C16. The battery cell monitoring circuit 12 includes the cell voltage measuring terminals Pcv11 to Pcv14, the cell balancing terminals Pcb11 to Pcb14, the current sources 30a to 30c, the switches SW11 to SW13, the switches SW21 to SW23, resistances R21 to R24, the P-channel MOS transistors PT1 to PT4, the differential amplifier 32, the AD converter 33, the sequencer circuit 34, the interface unit 35, and the register 36.

Here, the notations subsequent to the resistance R24 and the P-channel MOS transistor PT4 are omitted.

One end of the resistance R21 is connected to the Node N5 and the cell balancing terminal Pcb11. A source of the P-channel MOS transistor PT1 as a detection unit is connected to the Node N4 and the cell voltage measuring terminal Pcv11, a gate of the P-channel MOS transistor PT1 is connected to the other end of the resistance R21, a drain of the P-channel MOS transistor PT1 is connected to the Node N7, and information of an open determination result of the cell balancing terminal Pcb11 is outputted from the Node N7 side.

One end of the resistance R22 is connected to the Node N15 and the cell balancing terminal Pcb12. A source of the P-channel MOS transistor PT2 as a detection unit is connected to the Node N14 and the cell voltage measuring terminal Pcv12, a gate of the P-channel MOS transistor PT2 is connected to the other end of the resistance R22, a drain of the P-channel MOS transistor PT2 is connected to the Node N17, and information of an open determination result of the cell balancing terminal Pcb12 is outputted from the Node N17 side.

One end of the resistance R23 is connected to the Node N5a and the cell balancing terminal Pcb13. A source of the P-channel MOS transistor PT3 as a detection unit is connected to the Node N4a and the cell voltage measuring terminal Pcv13, a gate of the P-channel MOS transistor PT3 is connected to the other end of the resistance R23, a drain of the P-channel MOS transistor PT3 is connected to the Node N7a, and information of an open determination result of the cell balancing terminal Pcb13 is outputted from the Node N7a side.

One end of the resistance R24 is connected to the Node N15a and the cell balancing terminal Pcb14. A source of the P-channel MOS transistor PT4 as a detection unit is connected to the Node N14a and the cell voltage measuring terminal Pcv14, a gate of the P-channel MOS transistor PT4 is connected to the other end of the resistance R24, a drain of the P-channel MOS transistor PT4 is connected to the Node N17a, and information of an open determination result of the cell balancing terminal Pcb14 is outputted from the Node N17a side.

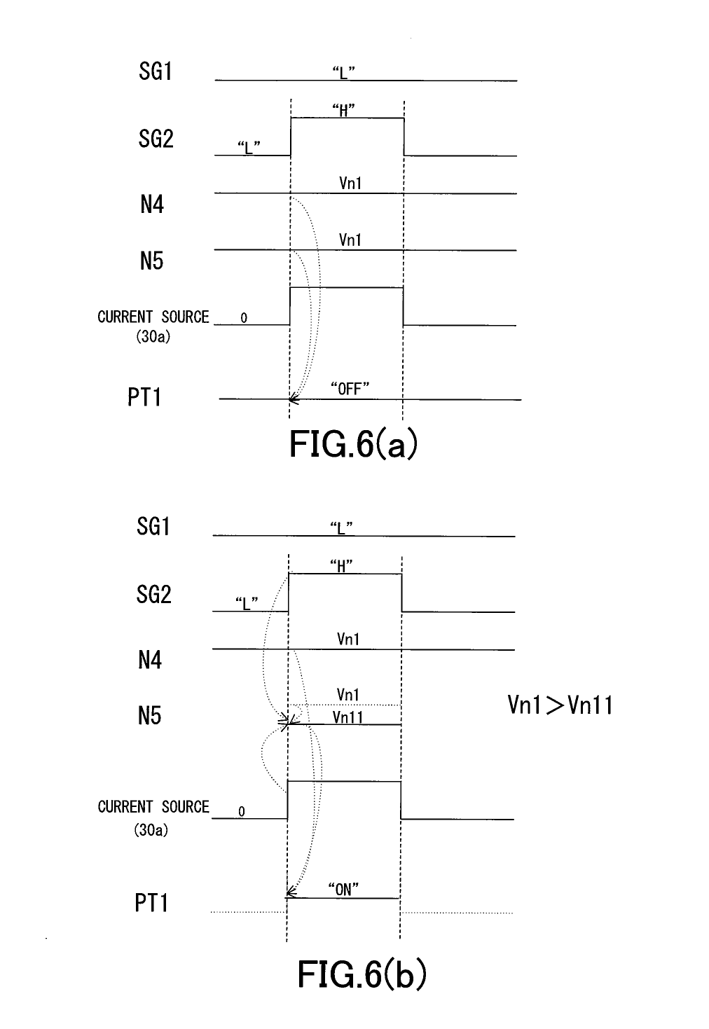

Next, detection of an abnormity of a cell balancing terminal by the battery cell monitoring circuit is described with reference to FIG. 6. FIG. 6(a) is a timing chart illustrating the open detection operation of the battery cell monitoring circuit in the case where the cell balancing terminal is normal. FIG. 6(b) is a timing chart illustrating the open detection operation of the battery cell monitoring circuit in the case where the cell balancing terminal is open. Here, determination on whether or not the cell balancing terminal Pcb11 is open is described as an example.

As illustrated in FIG. 6(a), when the cell balancing terminal Pcb11 and the cell balancing terminal Pcb12 are normal, the switch SW11 is turned off with the control signal SG1 of a low level in a disable state, and the switch SW21 is turned on with the control signal SG2 of a high level in an enable state, and then a current flows through the current source 30a. At the moment, the Node N4 and the Node N5 have the same potential (voltage Vn1 at the Node N1) because the Node N5 is electrically connected to the positive electrode side of the battery cell DC1. Consequently, the P-channel MOS transistor PT1 is off because the source and gate of the P-channel MOS transistor PT1 have the same potential.

As illustrated in FIG. 6(b), when the cell balancing terminal Pcb12 is normal and the cell balancing terminal Pcb11 is open, the switch SW11 is turned off with the control signal SG1 of a low level in a disable state, and the switch SW21 is turned on with the control signal SG2 of a high level in an enable state, and then a current flows through the current source 30a. At the moment, the Node N5 has the voltage (voltage Vn11 at the Node N11) at the negative electrode side of the battery cell DC1 because the Node N5 is not electrically connected to the positive electrode side of the battery cell DC1. Consequently, the potential of the gate of the P-channel MOS transistor PT1 becomes lower than the potential of the source of the P-channel MOS transistor PT1, and thus the P-channel MOS transistor PT1 is turned on, and a high-level signal is outputted from the drain side. That is to say, it can be determined that the cell balancing terminal Pcb11 is open. It should be noted that a detection result at the P-channel MOS transistor PT1 is determined by a determination unit (not shown) of the battery cell monitoring circuit 121.

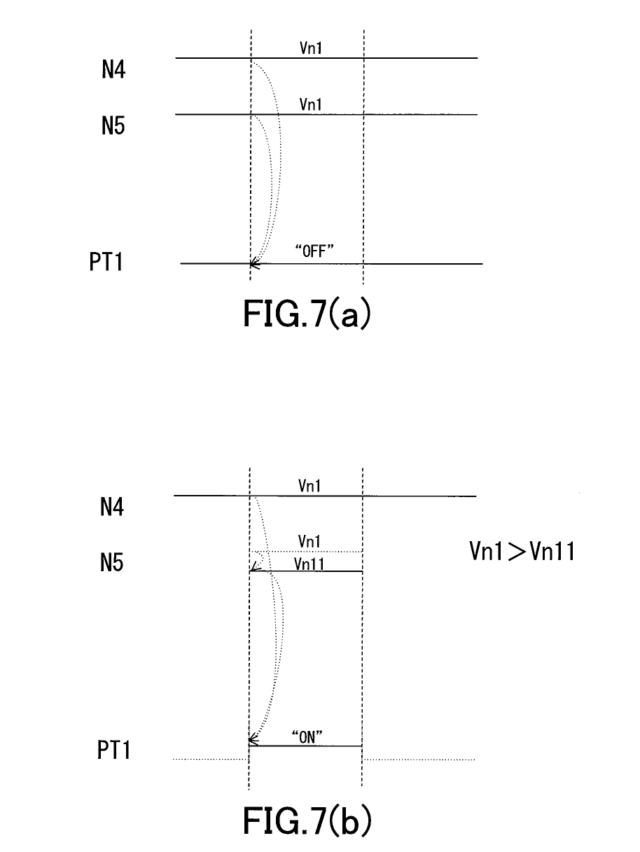

Next, detection of an abnormity of a switch by the battery cell monitoring circuit is described with reference to FIG. 7. FIG. 7(a) is a timing chart illustrating the short detection operation of the battery cell monitoring circuit in the case where the cell balancing switch is OFF. FIG. 7(b) is a timing chart illustrating the short detection operation of the battery cell monitoring circuit in the case where the cell balancing switch has a short-circuit failure. Here, determination of a failure of the switch SW11 is described as an example.

As illustrated in FIG. 7(a), when the cell balancing terminal Pcb11 and the cell balancing terminal Pcb12 are normal, the switch SW21 is turned off with the control signal SG2 of a low level in a disable state, and the P-channel MOS transistor is turned off when the Node N4 and the Node N5 have the same potential (voltage Vn1 at the Node N1). In the above case, it can be determined that no short-circuit failure has occurred at the switch SW11.

As illustrated in FIG. 7(b), when the cell balancing terminal Pcb11 and the cell balancing terminal Pcb12 are normal, the switch SW21 is turned off with the control signal SG2 of a low level in a disable state, the P-channel MOS transistor is turned on when the potential of the Node N5 becomes lower than the potential of the Node N4. In the above case, it can be determined that a short-circuit failure has occurred at the switch SW11.

As described above, according to the battery cell monitoring circuit, the battery cell module and the automobile with the battery cell module of the embodiment, the battery cell module 201 includes the battery cell unit 11 in which battery cells are stacked, and the battery cell monitoring circuit 121. The battery cell monitoring circuit 121 includes the cell voltage measuring terminals Pcv11 to Pcv14, the cell balancing terminals Pcb11 to Pcb14, the current sources 30a to 30c, the switches SW11 to SW13, the switches SW21 to SW23, resistances R21 to R24, the P-channel MOS transistors PT1 to PT4, the detection circuits 31a to 31d, the differential amplifier 32, the AD converter 33, the sequencer circuit 34, the interface unit 35, and the register 36. The P-channel MOS transistor as a detection unit of the battery cell monitoring circuit 121 performs on/off operation in accordance with the potentials at the source and the gate based on the low-level control signal SG1 and the high-level control signal SG2, and then outputs a detection signal from the drain side. A detection result at the P-channel MOS transistor is transmitted to the MCU.

Accordingly, whether or not a cell balancing terminal is in an open failure can be immediately determined. The MCU can recognize a result of an abnormity of the cell balancing terminal swiftly. Consequently, when an abnormity occurs in a battery cell module, the relevant battery cell unit and/or battery cell monitoring circuit can be immediately repaired or replaced, and thus the safety of the automobile can be improved.

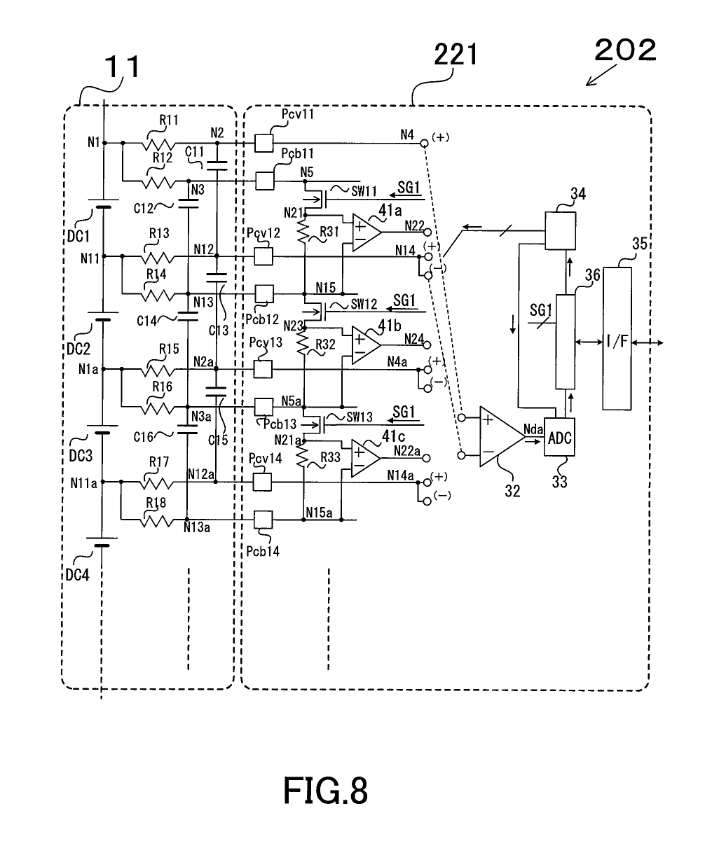

A battery cell monitoring circuit, a battery cell module, and an automobile with a battery cell module according to a third embodiment will be described with reference to the drawings. FIG. 8 is a circuit diagram illustrating the schematic configuration of a battery cell monitoring circuit and a battery cell. In the embodiment, the configuration of the battery cell monitoring circuit is changed.

Hereinafter, the same components as those of the first embodiment are labeled with the same reference symbols and description is omitted, and only different components are described.

As illustrated in FIG. 8, a battery cell module 202 is provided with the battery cell 11 and a battery cell monitoring circuit 221. Similarly to the first embodiment, the battery cell module 202 constitutes the battery cell module, which is mounted on an automobile.

The battery cell unit 11 includes the battery cells DC1 to DC4, the resistances R11 to R18, and the condensers C11 to C16. The battery cell monitoring circuit 221 includes the cell voltage measuring terminals Pcv11 to Pcv14, the cell balancing terminals Pcb11 to Pcb14, the resistances R31 to R33, the switches SW11 to SW13, the detection circuits 41a to 41c, the differential amplifier 32, the AD converter 33, the sequencer circuit 34, the interface unit 35, and the register 36.

Here, the notations subsequent to the resistance R33, the switch SW13, and the detection circuit 41c are omitted.

The switch SW11 is turned on/off based on the control signal SG1, and serves as a cell balancing switch. A drain of the N-channel MOS transistor as the switch SW11 is connected to the Node N5 and the cell balancing terminal Pcb11, the control signal SG1 is inputted to a gate of the N-channel MOS transistor as the switch SW11, and a source of the N-channel MOS transistor as the switch SW11 is connected to the Node N21. One end of the resistance R31 is connected to the Node N21, and the other end of the resistance R31 is connected to the Node N15 and the cell balancing terminal Pcb12.

The switch SW12 is turned on/off based on the control signal SG1, and serves as a cell balancing switch. A drain of the N-channel MOS transistor as the switch SW12 is connected to the Node N15 and the cell balancing terminal Pcb12, the control signal SG1 is inputted to a gate of the N-channel MOS transistor as the switch SW12, and a source of the N-channel MOS transistor as the switch SW12 is connected to the Node N23. One end of the resistance R32 is connected to the Node N23, and the other end of the resistance R32 is connected to the Node N5a and the cell balancing terminal Pcb13.

The switch SW13 is turned on/off based on the control signal SG1, and serves as a cell balancing switch. A drain of the N-channel MOS transistor as the switch SW13 is connected to the Node N5a and the cell balancing terminal Pcb13, the control signal SG1 is inputted to a gate of the N-channel MOS transistor as the switch SW13, and a source of the N-channel MOS transistor as the switch SW13 is connected to the Node N21a. One end of the resistance R33 is connected to the Node N21a, and the other end of the resistance R33 is connected to the cell balancing terminal Pcb14.

The detection circuit 41a as a detection unit is a current detection circuit. The + (positive) port of the detection circuit 41a on the input side is connected to the Node N21 (one end of the resistance R31), and the − (negative) port of the detection circuit 41a on the input side is connected to the Node N15 (the other end of the resistance R31), and thus the detection circuit 41a detects a current flowing through both ends of the resistance R31, and outputs a detection result from the Node N22 on the output side.

The detection circuit 41b as a detection unit is a current detection circuit. The + (positive) port of the detection circuit 41b on the input side is connected to the Node N23 (one end of the resistance R32), and the − (negative) port of the detection circuit 41b on the input side is connected to the Node N5a (the other end of the resistance R32), and thus the detection circuit 41b detects a current flowing through both ends of the resistance R32, and outputs a detection result from the Node N24 on the output side.

The detection circuit 41c as a detection unit is a current detection circuit. The + (positive) port of the detection circuit 41c on the input side is connected to the Node N21a (one end of the resistance R33), and the − (negative) port of the detection circuit 41c on the input side is connected to the Node N15 (the other end of the resistance R33), and thus the detection circuit 41b detects a current flowing through both ends of the resistance R32, and outputs a detection result from the Node N22a on the output side.

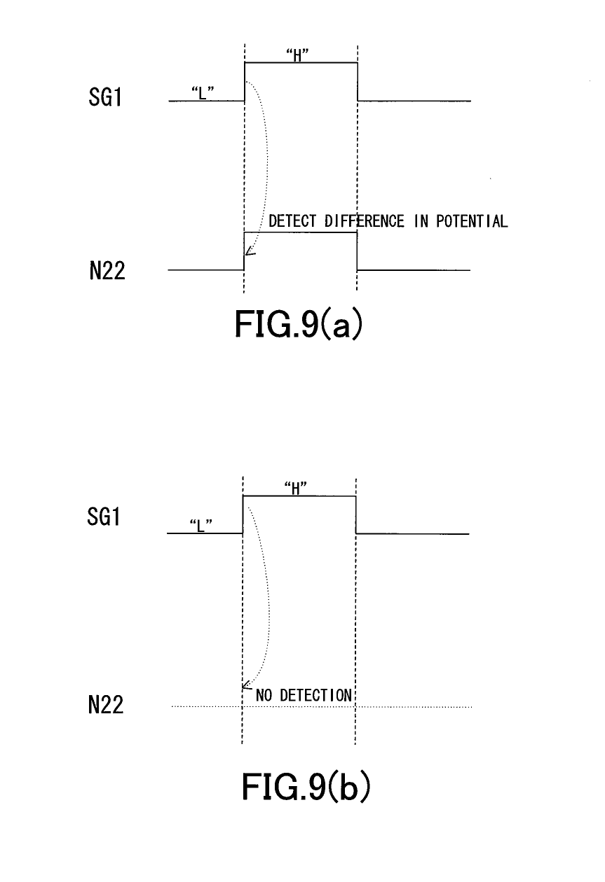

Next, detection of an abnormity of a cell balancing terminal by the battery cell monitoring circuit is described with reference to FIG. 9. FIG. 9(a) is a timing chart illustrating the current detection operation of the battery cell monitoring circuit in the case where the cell balancing terminal is normal. FIG. 9(b) is a timing chart illustrating the current detection operation of the battery cell monitoring circuit in the case where the cell balancing terminal is open. Here, determination on whether or not the cell balancing terminals Pcb11 and Pcb2 are open is described as an example.

As illustrated in FIG. 9(a), when the cell balancing terminal Pcb11 and the cell balancing terminal Pcb12 are both normal, the switch SW11 is turned on with the control signal SG1 of a high level in an enable state, and then when a current flows through the resistance R31, the detection circuit 41a detects a voltage generated at the resistance R31 and outputs a detection result from the Node N22.

As illustrated in FIG. 9(b), when at least one of the cell balancing terminal Pcb11 and the cell balancing terminal Pcb12 is open, no current flows through the resistance R31 even though the switch SW11 is turned on with the control signal SG1 of a high level in an enable state. Consequently, the detection circuit 41a detects nothing. That is to say, it can be determined that at least one of the cell balancing terminal Pcb11 and the cell balancing terminal Pcb12 is open. It should be noted that a detection result by each of the detection circuits 41a to 41c is determined by a determination unit (not shown) of the battery cell monitoring circuit 221.

As described above, according to the battery cell monitoring circuit, the battery cell module and the automobile with the battery cell module of the embodiment, the battery cell module 202 includes the battery cell unit 11 and the battery cell monitoring circuit 221. The battery cell monitoring circuit 221 includes the cell voltage measuring terminals Pcv11 to Pcv14, the cell balancing terminals Pcb11 to Pcb14, the resistances R31 to R33, the switches SW11 to SW13, the detection circuits 41a to 41c, the differential amplifier 32, the AD converter 33, the sequencer circuit 34, the interface unit 35, and the register 36. The detection circuit of the battery cell monitoring circuit 221 compares a voltage at the + (positive) port on the input side with a voltage at the − (negative) port on the input side based on the control signal SG1 of a high level. A result of the comparison is transmitted to the MCU.

Accordingly, whether or not a cell balancing terminal is in an open failure can be immediately determined. The MCU can recognize a result of an abnormity of the cell balancing terminal swiftly. Consequently, when an abnormity occurs in a battery cell module, the relevant battery cell unit and/or battery cell monitoring circuit can be immediately repaired or replaced, and thus the safety of the automobile can be improved.

It should be noted that although a plurality of battery cell modules 20 are connected in series in the first embodiment, the invention is not necessarily limited to the above case. The plurality of battery cell modules 20 may be connected in parallel, or the plurality of battery cell modules 20 may be connected in series and parallel.

In the first to third embodiments, a plurality of battery cells are stacked (connected in series) and formed, however, the invention is not necessarily limited to the above case. A plurality of battery cells may be arranged in parallel. In the above case, even when one or more battery cells are out of order, as long as at least one battery cell is normal, the battery cell module can maintain the operating state.

While certain embodiments have been described, these embodiments have been presented by way of example only, and are not intend to limit the scope of the inventions. Indeed, the novel embodiments described herein may be embodied in a variety of the other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery cell monitoring circuit for detecting an abnormity in cell balancing and a terminal of a battery cell, the battery cell monitoring circuit comprising:
a first cell voltage measuring terminal configured to be connected to a positive electrode side of the battery cell;
a first cell balancing terminal configured to be connected to the positive electrode side of the battery cell, and configured to be arranged in parallel with the first cell voltage measuring terminal;
a second cell voltage measuring terminal configured to be connected to a negative electrode side of the battery cell;
a second cell balancing terminal configured to be connected to the negative electrode side of the battery cell, and configured to be arranged in parallel with the second cell voltage measuring terminal;
a first switch having one end connected to the first cell balancing terminal, and the other end connected to the second cell balancing terminal, the first switch configured to perform cell balancing by being turned on/off based on a first control signal;
a current source and a second switch which are arranged in parallel with the first switch and are connected in series between the one end and the other end of the first switch, the current source configured to supply a current, the second switch configured to be turned on/off based on a second control signal;
a first detection unit configured to receive a first cell voltage measuring terminal voltage and a first cell balancing terminal voltage, and configured to detect a terminal open state; and
a second detection unit configured to receive a second cell voltage measuring terminal voltage and a second cell balancing terminal voltage, and configured to detect a terminal open state.

2. The battery cell monitoring circuit according to claim 1, wherein
the first detection unit is a first comparator configured to receive the first cell voltage measurement terminal voltage at a first input side, to receive the first cell balancing terminal voltage at a second input side, and to compare the first cell voltage measuring terminal voltage with the first cell balancing terminal voltage, and
the second detection unit is a second comparator configured to receive the second cell voltage measurement terminal voltage at a first input side, to receive the second cell balancing terminal voltage at a second input side, and to compare the second cell voltage measuring terminal voltage with the second cell balancing terminal voltage.

3. The battery cell monitoring circuit according to claim 1, wherein
the first detection unit is a first P-channel MOS transistor having a first terminal to which the first cell voltage measurement terminal voltage is applied, and a control terminal to which the first cell balancing terminal voltage is applied and a second terminal configured to output a first detection signal indicating detection of an terminal open state, and
the second detection unit is a second P-channel MOS transistor having a first terminal to which the second cell voltage measurement terminal voltage is applied, and a control terminal to which the second cell balancing terminal voltage is applied and a second terminal configured to output a second detection signal indicating detection of an terminal open state.

4. The battery cell monitoring circuit according to claim 3, wherein
when the first and second switches are off and the first detection signal at a high level is outputted, it is determined that the first switch has a short-circuit failure.

5. The battery cell monitoring circuit according to claim 1, wherein
the first switch is an N-channel MOS transistor.

6. The battery cell monitoring circuit according to claim 1, wherein
a positive electrode voltage of the battery cell is applied via a filter to the first cell voltage measuring terminal and the first cell balancing terminal, and
a negative electrode voltage of the battery cell is applied via a filter to the second cell voltage measuring terminal and the second cell balancing terminal.

7. The battery cell monitoring circuit according to claim 1, further comprising:
a first resistance configured to set a discharge current, and configured to be provided between the positive electrode side of the battery cell and the first cell voltage measuring terminal,
a second resistance configured to set a discharge current, and configured to be provided between the positive electrode side of the battery cell and the first cell balancing terminal,
a third resistance configured to set a discharge current, and configured to be provided between the negative electrode side of the battery cell and the second cell voltage measuring terminal, and
a fourth resistance configured to set a discharge current, and configured to be provided between the negative electrode side of the battery cell and the second cell balancing terminal.

8. The battery cell monitoring circuit according to claim 1, wherein
the battery cell monitoring circuit is applied to an EV, an HEV, a fuel cell vehicle, smart grid, energy harvesting and a mobile.

9. A battery cell monitoring circuit for detecting an abnormity in cell balancing and a terminal of a battery cell, the battery cell monitoring circuit comprising:
a first cell voltage measuring terminal configured to be connected to a positive electrode side of the battery cell;
a first cell balancing terminal configured to be connected to the positive electrode side of the battery cell, and configured to be arranged in parallel with the first cell voltage measuring terminal;
a second cell voltage measuring terminal configured to be connected to a negative electrode side of the battery cell;
a second cell balancing terminal configured to be connected to the negative electrode side of the battery cell, and configured to be arranged in parallel with the second cell voltage measuring terminal;
a first switch having one end configured to be connected to the first cell balancing terminal, the first switch configured to perform cell balancing by being turned on/off based on a first control signal;
a first resistance having one end connected to the other end of the first switch, and the other end connected to the second cell balancing terminal; and
a detection circuit having a first input side connected to the one end of the first resistance, and a second input side connected to the other end of the first resistance, the detection circuit configured to detect a current flowing through the first resistance.

10. The battery cell monitoring circuit according to claim 9, wherein
the detection circuit is a comparator.

11. The battery cell monitoring circuit according to claim 9, wherein
the first switch is an N-channel MOS transistor.

12. The battery cell monitoring circuit according to claim 9, wherein
a positive electrode voltage of the battery cell is applied via a filter to the first cell voltage measuring terminal and the first cell balancing terminal, and
a negative electrode voltage of the battery cell is applied via a filter to the second cell voltage measuring terminal and the second cell balancing terminal.

13. The battery cell monitoring circuit according to claim 9, further comprising:
a second resistance configured to set a discharge current, and configured to be provided between the positive electrode side of the battery cell and the first cell voltage measuring terminal,
a third resistance configured to set a discharge current, and configured to be provided between the positive electrode side of the battery cell and the first cell balancing terminal,
a fourth resistance configured to set a discharge current, and configured to be provided between the negative electrode side of the battery cell and the second cell voltage measuring terminal, and
a fifth resistance configured to set a discharge current, and configured to be provided between the negative electrode side of the battery cell and the second cell balancing terminal.

14. The battery cell monitoring circuit according to claim 9, wherein
the battery cell monitoring circuit is applied to an EV, an HEV, a fuel cell vehicle, smart grid, energy harvesting and a mobile.

15. A battery cell module comprising:
a battery cell unit in which battery cells are stacked or arranged in parallel; and
a battery cell monitoring circuit for detecting an abnormity in cell balancing and a terminal of the battery cell, wherein
the battery cell monitoring circuit includes:
a first cell voltage measuring terminal configured to be connected to a positive electrode side of the battery cell,
a first cell balancing terminal configured to be connected to the positive electrode side of the battery cell, and configured to be arranged in parallel with the first cell voltage measuring terminal,
a second cell voltage measuring terminal configured to be connected to a negative electrode side of the battery cell,
a second cell balancing terminal configured to be connected to the negative electrode side of the battery cell, and configured to be arranged in parallel with the second cell voltage measuring terminal,
a first switch having one end connected to the first cell balancing terminal, and the other end connected to the second cell balancing terminal, the first switch configured to perform cell balancing by being turned on/off based on a first control signal,
a current source and a second switch which are arranged in parallel with the first switch and are connected in series between the one end and the other end of the first switch, the current source configured to supply a current, the second switch configured to be turned on/off based on a second control signal;
a first detection unit configured to receive a first cell voltage measuring terminal voltage and a first cell balancing terminal voltage, and configured to detect a terminal open state, and
a second detection unit configured to receive a second cell voltage measuring terminal voltage and a second cell balancing terminal voltage, and configured to detect a terminal open state.

16. The battery cell module according to claim 15, wherein
the battery cell module is applied to an EV, an HEV, and a fuel cell vehicle.
